(19) United States
(12) Patent Application Publication
(10) Pub. No.: US 2017/0004294 A1
(43) Pub. Date: Jan. 5, 2017

(54) USING SPEECH TO UNLOCK AN ELECTRONIC DEVICE HAVING A PATTERN-BASED UNLOCKING MECHANISM

(71) Applicant: MOTOROLA MOBILITY LLC, Chicago, IL (US)

(72) Inventors: Amit Kumar Agrawal, Bangalore (IN); William S. Pierce, Algonquin, IL (US); Lawrence A. Willis, Dubuque, IA (US)

(21) Appl. No.: 14/800,801

(22) Filed: Jul. 16, 2015

Related U.S. Application Data
(60) Provisional application No. 62/186,514, filed on Jun. 30, 2015.

(51) Int. Cl. G06F 21/32; G06F 21/36; G06F 3/01; G10L 17/24

(52) U.S. Cl. CPC G06F 21/32; G10L 17/24; G06F 21/36; G06F 3/016

(57) ABSTRACT

A method and apparatus for using speech to unlock an electronic device having a pattern-based unlocking mechanism includes the electronic device receiving tactile input to set an unlocking pattern relative to a pattern array of an electronic device, wherein the unlocking pattern can be used to unlock the electronic device. The method also includes mapping a character sequence to the unlocking pattern. The method further includes the electronic device detecting that it is in a locked state and unlocking itself upon detecting speech that includes at least a portion of the character sequence mapped to the unlocking pattern.

### CROSS-REFERENCE TO RELATED APPLICATIONS

The present application claims priority to U.S. Provisional Patent Application 62/186,514, filed on Jun. 30, 2015, which is incorporated herein by reference in its entirety.

### TECHNICAL FIELD

The present disclosure relates generally to unlocking electronic devices and more specifically to using speech to unlock electronic devices that have been locked with a pattern.

### BACKGROUND

As electronic devices have decreased in size while increasing in functionality, traditional input peripherals, such as keyboards and mice, have been increasingly abandoned in favor of direct input means, such as touch. This is especially true of portable electronic devices, for which peripherals can be unwieldy. With tactile input, a user can interact directly, in a graphical context, with output rendered on a touchscreen of the device. This includes unlocking a device having a pattern-based unlocking mechanism by tactilely inputting an unlocking pattern on the touchscreen. Tactilely inputting the unlocking pattern, however, momentarily draws the user's visual attention away from other tasks that might also require it.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 shows an electronic device having a pattern-based unlocking mechanism;

FIG. 2 is a flowchart of a method for using speech to unlock an electronic device having a pattern-based unlocking mechanism;

FIG. 3 is a series of four screenshots of a touchscreen illustrating the setting of an unlocking pattern;

FIG. 4 is a screenshot of a touchscreen illustrating the vocalizing of an unlocking pattern;

FIG. 5 is a screenshot of a touchscreen illustrating the vocalizing of an unlocking pattern;

FIG. 6 is a flowchart of a method for using speech to unlock an electronic device having a pattern-based unlocking mechanism;

FIG. 7 is a screenshot of a touchscreen illustrating the setting of an unlocking pattern;

FIG. 8 is a screenshot of a touchscreen illustrating the vocalizing of an unlocking pattern;

FIG. 9 is a screenshot of a touchscreen illustrating the vocalizing of an unlocking pattern; and

FIG. 10 is a block diagram of an electronic device.

### DETAILED DESCRIPTION

Turning to the drawings, wherein like reference numerals refer to like elements, techniques of the present disclosure are illustrated as being implemented in a suitable environment. The following description is based on embodiments of the claims and should not be taken as limiting the claims with regard to alternative embodiments that are not explicitly described herein.

Generally speaking, the present disclosure provides a method and apparatus for using speech to unlock an electronic device having a pattern-based unlocking mechanism. More specifically, an electronic device associates a sequence of characters with a pattern used to unlock the device by tracing the pattern on a touchscreen of the device. Upon speaking the character sequence to the electronic device, the device unlocks itself as if the unlocking pattern had been traced on its touchscreen.

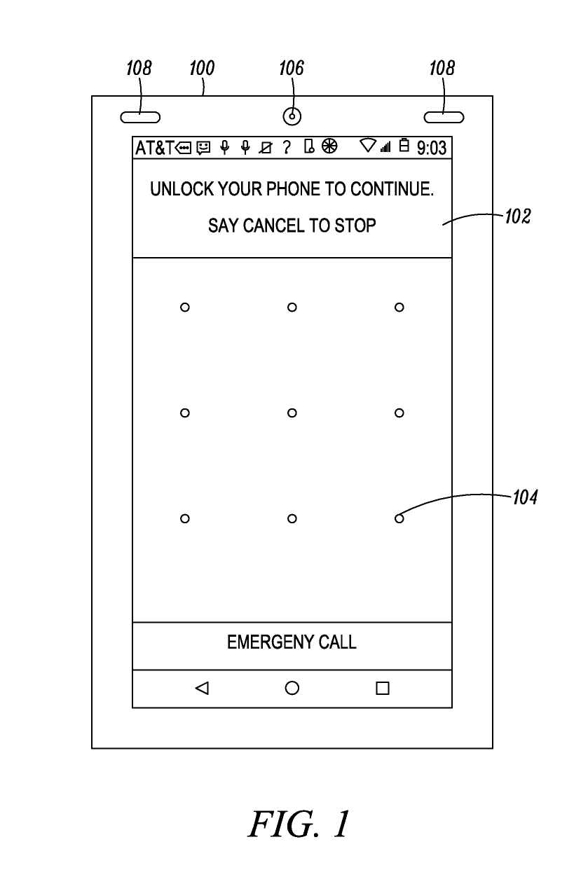

FIG. 1 shows a smartphone 100 configured to unlock a pattern-based unlocking mechanism through voice input. While the device 100 is shown as a smartphone, the present teachings can be used with other electronic devices.

The smartphone 100 is shown to include a touchscreen 102, a microphone 106, and stereo speakers 108. The touchscreen 102 registers tactile contact, which allows a user of the smartphone 100 to enter an unlocking pattern into the smartphone 100. The smartphone 100 uses the entered unlocking pattern to either set its pattern-based unlocking mechanism or to transition itself from a locked to an unlocked state.

The microphone 106 receives speech spoken by the user of the device 100 as voice input. In describing included embodiments, the words “speech” and “voice” are used interchangeably. The smartphone 100 is configured to process the voice input received by the microphone 106 and to extract from it the names of characters spoken by the user. For some embodiments, these characters are displayed on the touchscreen 102 or presented to the user as or after the user enters the unlocking pattern into the smartphone 100. For other embodiments, the characters are displayed on the touchscreen 102 as the user enters the unlocking pattern into the smartphone 100.

The speakers 108 enable the smartphone 100 to output sound, which can includes voice output. The smartphone 100 can use the speakers 108 to prompt the user to provide input or to communicate to the user information that will aid the user in using speech to unlock the smartphone 100.

Shown on the touchscreen 102 of the smartphone 100 is a pattern array 104. A pattern array is a configuration of multiple discrete and visually identifiable locations or nodes. The pattern array 104 has nine nodes of approximately equal spacing, which are configured to form a three-by-three array. Through sequential contact with some or all of the nodes, a user inputs into the smartphone 100 an unlocking pattern. While entering the unlocking pattern, the user's contact with the touchscreen 102 can be continuous or intermittent. For example, the user can drag his finger across the touchscreen 102 to swipe from one node to the next, or the user can tap on the nodes as if he were dialing a pushbutton telephone. Upon entering an unlocking pattern set for the smartphone 100, the smartphone 100 is unlocked. The smartphone 100 can also be unlocked by speaking a vocal equivalent for the unlocking pattern.

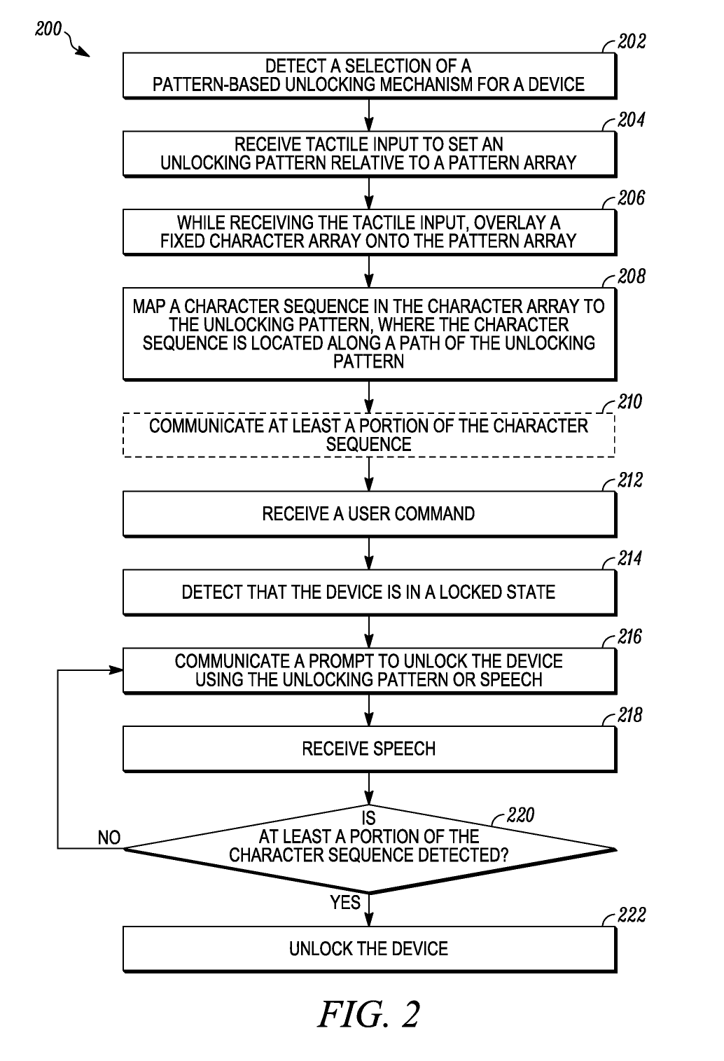

FIG. 2 is a flowchart of a method 200 performed by the smartphone 100 to set an unlocking pattern and to unlock itself using speech. Specifically, the smartphone 100 detects 202 a user selecting a pattern-based unlocking mechanism. The user is seeking a level of security, for instance, and chooses to avail himself of the pattern-based unlocking mechanism available on his smartphone 100.

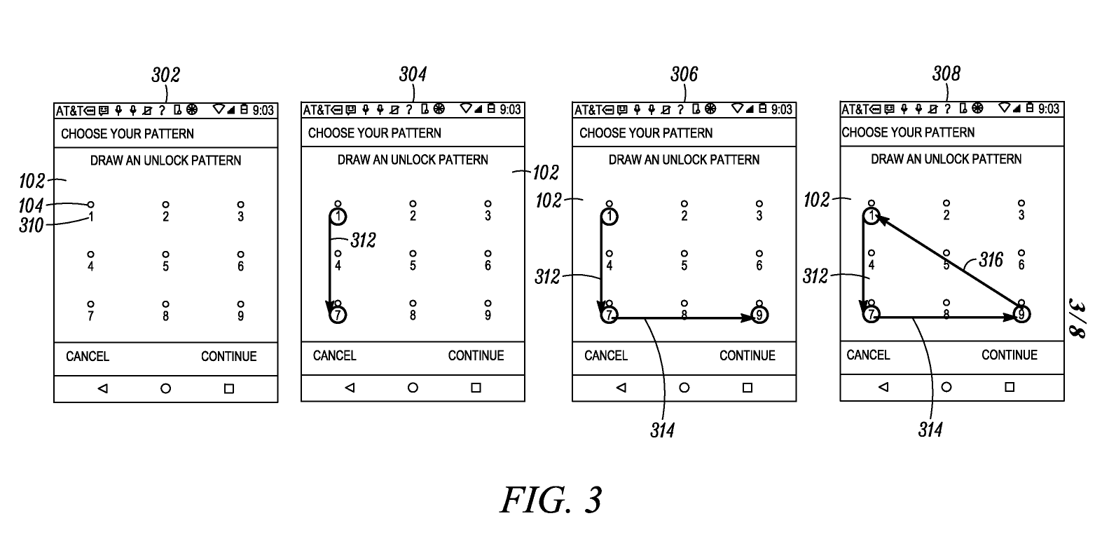

FIG. 3 illustrates setting the unlocking pattern with an ordered series of four screenshots 302, 304, 306, 308 of the touchscreen 102. The screenshots 302, 304, 306, 308 illustrate the user entering a triangular unlocking pattern into the smartphone 100 to set as the unlocking pattern. When the smartphone 100 detects 202 (FIG. 2) that the user is selecting the pattern-based unlocking mechanism, it presents the user with the screen 302. The screen 302 presents the user with the same three-by-three pattern array 104 shown in FIG. 1. From the user, the smartphone 100 receives 204 (FIG. 2) tactile input on its touchscreen 102 to set the unlocking pattern relative to the pattern array 104.

While a simple two-dimensional three-by-three pattern array 104 is shown in FIG. 3 for illustrative purposes, other pattern arrays can be used. In a first example, a pattern array has twelve nodes arranged in four rows and three columns. In a second example, a pattern array has eight nodes, created by displaying the eight vertices of a cube as a two-dimensional image on the touchscreen 102. In a third example, the nodes of a pattern array are arranged on the touchscreen 102 as another geometric shape, such as a star or hexagon.

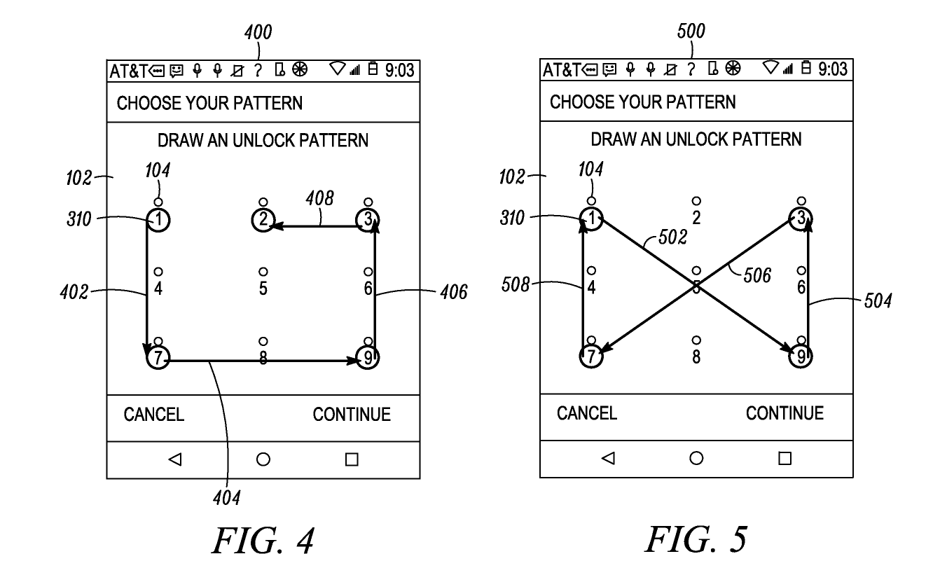

While the smartphone 100 is receiving 204 the tactile input, the smartphone 100 overlays 206 (FIG. 2) a character array 310 onto the pattern array 104. A character array is a one-to-one or a multiple-to-one correspondence of characters to nodes of a pattern array. Individual characters can be numbers, letters, or any symbol having a name which can be spoken and identified using language. The characters label each node of a pattern array. Numbers uniquely identify each node of the three-by-three pattern array 104 shown in FIG. 3, for example, and also as shown in FIGS. 4, 5, 8 and 9.

For example, the user places his finger on node “1” and drags it over the touchscreen 102 across node “4” to node “7.” This defines a line segment 312 shown in the screenshot 304. As shown in the screenshot 306, the user changes direction at node “7” and swipes over node “8” to node “9.” This defines a line segment 314. Finally, in screenshot 308, the user again changes direction at node “9” and swipes over node “5” back to node “1” to complete the unlocking pattern.

In some embodiments, the user breaking tactile contact with the touchscreen 102 or the user not moving his finger for a programmed length of time signals the smartphone 100 that the user is finished inputting the unlocking pattern. In other embodiments, the smartphone 100 is programmed to accept a minimum number or a fixed number of line segments as an unlocking pattern. In a first example, the smartphone 100 only accepts an unlocking pattern having three or more line segments. In a second example, the smartphone 100 sets the first four line segments as the unlocking pattern. In a third example, the user taps an icon or a virtual button displayed on the touchscreen 102 when he finishes inputting the unlocking pattern.

For some embodiments, the smartphone 100 maps 208 (FIG. 2) one or more character sequences in the character array 310 to the unlocking pattern. For an embodiment, this includes the smartphone 100 overlaying 206 (FIG. 2) the character array 310 onto the pattern array 104. In a further embodiment, the smartphone 100 also assigns one or more character sequences of the character array so that the character sequences are located along a path of the unlocking pattern. A character sequence is a sequence of characters that represents an unlocking pattern on a pattern array. Because characters are named, a character sequence can be spoken to unlock a pattern-locked electronic device.

A character sequence is located along a path of an unlocking pattern when each character in the sequence labels a pattern array node that lies on or is crossed by a line segment of the unlocking pattern. A character sequence {1, 4, 7, 8, 9, 5, 1}, for example, represents the unlocking pattern shown in the screenshot 308. Each character of the sequence labels a node which lies on at least one of the line segments 312, 314, 316 forming the unlocking pattern. Corner nodes “1,” “7,” and “9,” which are shown circled, each represent a beginning of one line segment and an end of another. The character “1” appears at both the beginning and the end of the character sequence because the unlocking pattern begins and ends on node “1.”

An unlocking pattern need not begin and end on the same node. The unlocking pattern can form an open rather than a closed pattern. Also, an unlocking pattern need not be continuous. A line segment need not begin upon the same node on which a previous line segment ended. Gaps can exist between the line segments of an unlocking pattern. An unlocking pattern can be formed, for example, from a first line segment from node “1” to node “7,” a second line segment from node “2” to node “8,” and a third line segment from node “3” to node “9.”

In some embodiments, the smartphone 100 assigns a character sequence along a unidirectional path of an unlocking pattern. The characters in the sequence are arranged in the same order as the direction of the nodes they label are traversed in creating the unlocking pattern. This direction is indicated in FIG. 3, and also in FIGS. 4, 5, 7, 8, and 9, by arrowheads appearing on the line segments shown for each figure.

In different embodiments, the same unlocking pattern is represented by different character sequences. For some embodiments, this is a consequence of having multiple characters labeling a single node for some or all of the nodes in a pattern array. In other embodiments, characters corresponding to nodes that lie on a line segment of an unlocking pattern may be omitted from a character sequence if the nodes do not define the beginning or the end of the line segment. The unlocking pattern shown in the screenshot 308, for example, is represented by both the character sequence {1, 4, 7, 8, 9, 5, 1} and by a character sequence {1, 7, 9, 1}. The first character sequence is an entire or full character sequence because it includes a character for every node in the unlocking pattern. The latter character sequence is a partial character sequence because it does not include a character for every node in the unlocking pattern. With the characters “4,” “8,” and “5” omitted from the latter sequence, the latter sequence, when traced on the pattern array 104, still forms the same unlocking pattern as the first sequence.

The partial character sequence {1, 7, 9, 1} also represents the minimum character sequence for the unlocking pattern shown in screenshot 308. Where a unidirectional path of an unlocking pattern correlates to a plurality of line segments, and where a character sequence is mapped to the unlocking pattern, the unlocking pattern comprises at a minimum, for each line segment, a first and a second character correlating to a beginning and an end of the line segment. The character sequence {1, 4, 7, 9, 1} represents a partial character sequence for the unlocking pattern shown in screenshot 308, which is neither the full character sequence nor the minimum character sequence for the unlocking pattern.

Additional examples of unlocking patterns and their associated character sequences are provided with reference to FIGS. 4 and 5. FIG. 4 shows a screenshot 400 of the touchscreen 102 illustrating an open unlocking pattern with respect to the pattern array 104 and the character array 310. The unlocking pattern is formed from four line segments 402, 404, 406, 408. The unlocking pattern begins with a user tracing his finger, or other implement, from node “1” to node “7,” thereby defining the first line segment 402. The unlocking pattern continues with the user tracing from node “7” to node “9,” which defines the second line segment 404. Up until this point, the unlocking pattern is the same as the unlocking pattern shown in FIG. 3. The unlocking pattern here, however, concludes with the user tracing from node “9” to node “3” and from the node “3” to the node “2.” This defines the line segments 406 and 408, respectively.

Alternatively, the user can input the unlocking pattern of FIG. 4 by tapping first node “1,” then node “7,” then node “9,” then node “3,” and finally node “2.” The unidirectional path of the unlocking pattern follows the order in which the nodes were tapped in inputting the pattern.

The character sequence {1, 4, 7, 8, 9, 6, 3, 2} represents the full character sequence assigned to the unlocking pattern of the screenshot 400. The minimum character sequence is {1, 7, 9, 3, 2}, as indicated by the circled characters. Partial character sequences include the circled characters “1,” “7,” “9,” “3,” and “2,” combined with any or all of the characters “4,” “8,” and “6,” and arranged in an order that follows the unidirectional path of the unlocking pattern from the first node “1” to the final node “2.”

FIG. 5 shows a screenshot 500 of the touchscreen 102 illustrating a crossed unlocking pattern with respect to the pattern array 104 and the character array 310. This crossed unlocking pattern is also a closed unlocking pattern. The unlocking pattern is formed from four line segments 502, 504, 506, and 508, the first and third of which cross at node “5.” To input the unlocking pattern, a user begins at node “1” and traces to node “9,” then to node “3,” then to node “7,” and finally back to node “1.” Alternatively, the user taps the nodes in the same order. It is the order in which the nodes are traced or tapped that defines the unidirectional path of the unlocking pattern.

The character sequence {1, 5, 9, 6, 3, 5, 7, 4, 1} represents the full character sequence assigned to the unlocking pattern of screenshot 500. The minimum character sequence is {1, 9, 3, 7, 1}. Partial character sequences include the circled characters “1,” “9,” “3,” and “7,” combined with any or all of the characters “5,” “6,” and “4,” and arranged in an order that follows the unidirectional path of the unlocking pattern from the first node “1” to the final node “1.”

Turning back to FIG. 2 and continuing the description of the method 200, the smartphone 100, in some instances, communicates 210 at least a portion of the character sequence mapped to the unlocking pattern set for the smartphone 100. The smartphone 100 communicates 210 the character sequence, in part or in full, using one or more output components of the smartphone 100, such as the touchscreen 102 or the speakers 108. An electronic device communicates in the present disclosure by presenting, transmitting, or conveying information to a user of the device. After assigning the character sequence {1, 7, 9, 1} for the unlocking pattern set for the smartphone 100, for example, the smartphone 100 displays the following message on its touchscreen 102: “You can unlock this device by speaking ‘1-7-9-1.’” The smartphone 100 may also announce this message using its speakers 108.

For some embodiments where the character array is a fixed character array, the smartphone 100 overlays the character array onto a pattern array only when the tactile input is initially received to set the unlocking pattern. A fixed character array means that the character array is not altered relative to a pattern array such that each node of the pattern array is labeled by the same character or set of characters from the character array each time an electronic device is unlocked. With a fixed character array, a same character sequence can be repeatedly spoken to unlock the electronic device multiple times. For the pattern array 104 shown in FIG. 3, for example, the upper left-hand node is always labeled by the character “1.” In a first embodiment, the character “1” labels the upper left-hand node each time the smartphone 100 is unlocked until a new unlocking pattern is set. In a second embodiment, the character “1” labels the upper left-hand node each time the smartphone 100 is unlocked irrespective of a new unlocking pattern being set.

In one embodiment for which the smartphone 100 overlays the character array 310 onto the pattern array 104 only when the tactile input is initially received to set the unlocking pattern, the user makes a point to remember, at the time he sets the unlocking pattern, a full or partial character sequence that will later unlock the smartphone 100. When unlocking the smartphone 100, the user speaks the character sequence from memory.

For a different embodiment, the smartphone 100 also overlays the character array 310 onto the pattern array 104 when prompting the user to unlock the smartphone 100. If the user remembers the unlocking pattern without remembering a character sequence for the unlocking pattern, the user can view the touchscreen 102 and see the character array 310 overlaid onto the pattern array 104. The user then reads aloud a proper character sequence from the character array 310 along a path of the unlocking pattern. The microphone 106 receives the speech, and after some speech processing, the smartphone 100 unlocks.

In another embodiment, the smartphone 100 communicates 210 multiple times at least a portion of the full character sequence for unlocking the smartphone 100 after the unlocking pattern is set. Using one or more output components, the smartphone 100 implements a user-training process for unlocking the smartphone 100 using speech instead of inputting the unlocking pattern through tactile contact. After the unlocking pattern is set, the smartphone 100 intermittently, or in accordance with a programmed schedule, communicates to the user a character sequence which the user can speak to unlock the smartphone 100. Through the repetitious communications, the user is trained to remember the character sequence. For one embodiment, the user has the option to terminate the training communications once he remembers the character sequence. Each time the smartphone 100 communicates the character sequence, for example, the user is presented with the option of tapping an icon or virtual button on the touchscreen 102 associated with a response: “Do not show this message again.”

At some point after setting the unlocking pattern, the user uses his smartphone 100 and enters a command that the smartphone 100 is configured to perform from an unlocked state. The smartphone 100 receives 212 the command, but detects 214 that the smartphone 100 is in a locked state. Responsively, the smartphone 100 communicates 216 a prompt for unlocking the smartphone 100 by using either the unlocking pattern set for the smartphone 100 or speech.

Upon being presented with the unlocking prompt, the user speaks a character sequence to unlock the smartphone 100. The smartphone 100 receives 218 the speech as voice input into its microphone 106. By using one or more voice processing components, such as a speech-processing module (“SPM”), the smartphone 100 detects and identifies the character sequence spoken by the user. The smartphone 100 then determines if the spoken character sequence meets a set of criteria before unlocking.

In one embodiment, the smartphone 100 is unlocked upon detecting that the speech includes the entire or full assigned character sequence located along the path of the unlocking pattern. For example, the speech includes the character sequence {1, 4, 7, 8, 9, 5, 1} for the unlocking pattern shown in screenshot 308.

In another embodiment, the smartphone 100 is unlocked upon detecting that the speech includes only a subset of characters included in the entire assigned character sequence located along the path of the unlocking pattern. For example, the smartphone 100 unlocks upon detecting any of the partial character sequences: {1, 4, 7, 8, 9, 1}, {1, 7, 8, 9, 5, 1}, {1, 4, 7, 9, 5, 1}, {1, 4, 7, 9, 1}, {1, 7, 8, 9, 1}, {1, 7, 9, 5, 1}, or {1, 7, 9, 1} for the unlocking pattern shown in screenshot 308.

In a further embodiment, the partial character sequence includes a minimum number of characters to satisfy an unlocking pin requirement for an operating system of the smartphone 100. For example, if a valid pin requires at least four characters and if a pin-based unlocking mechanism had been selected for the smartphone 100, than a valid character sequence for a pattern-based unlocking mechanism requires at least four characters. In this case, the minimum character sequence {1, 7, 9, 1} for the unlocking pattern shown in the screenshot 308 would unlock the smartphone 100. If a valid pin required at least five characters, then the smartphone 100 would not unlock upon detecting the character sequence {1, 7, 9, 1}, which has only four characters.

If the smartphone 100 detects 220 that the character sequence the user speaks is not at least a valid portion of the mapped character sequence, or is not a valid representation of the unlocking pattern, then the smartphone 100 again communicates 216 the prompt to unlock the smartphone 100. If the smartphone 100 detects 220 that the spoken character sequence is at least a valid portion of the mapped character sequence, or a valid representation of the unlocking pattern, then the smartphone 100 unlocks 222 itself.

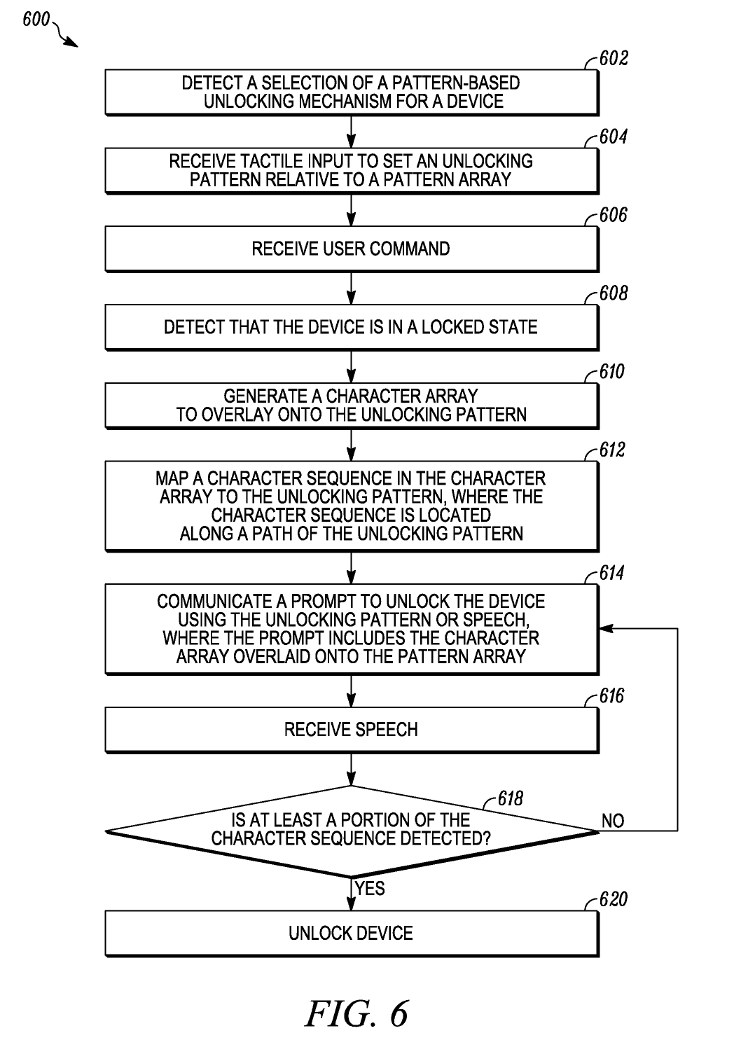

For a number of embodiments, the smartphone 100 uses a variable character array rather than a fixed character array. A variable character array means that the character array is altered relative to a pattern array such that at least one node of the pattern array is labeled by different characters at different times when an electronic device is being unlocked. As described herein, this is equivalent to using different character arrays. In a first example, a second character array includes the same characters as a first character array, but the characters are arranged differently relative to a pattern array. In a second example, a second character array includes characters that are different from characters included in a first character array. The use of a variable character array, or different character arrays, in using speech to unlock an electronic device having a pattern-based unlocking mechanism is described in detail with respect to FIG. 6.

FIG. 6 is a flowchart of a method 600 performed by the smartphone 100 to set an unlocking pattern and to unlock itself using speech together with a variable character array. Specifically, the smartphone 100 detects 602 a user selecting a pattern-based unlocking mechanism. Responsively, the smartphone 100 presents the user with the three-by-three pattern array 104 shown in FIG. 1. The smartphone 100 does not, however, overlay a character array onto the pattern array 104 when the user is setting an unlocking pattern. Instead, the smartphone 100 overlays a variable character array onto the pattern array 104 when the user unlocks the smartphone 100.

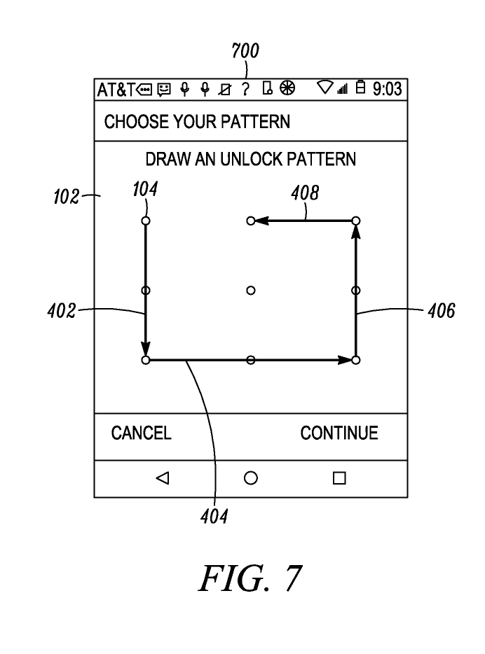

As the smartphone 100 receives 604 tactile input on its touchscreen 102 to set the unlocking pattern, the smartphone 100 sets the unlocking pattern relative to the pattern array 104, but the smartphone 100 does not yet map a character sequence of a character array to the unlocking pattern. FIG. 7 provides an example of an unlocking pattern set on the smartphone 100 for an embodiment in which the smartphone 100 uses a variable character array. In a screenshot 700, the unlocking pattern shown by FIG. 7 is the same unlocking pattern shown in screenshot 400, and therefore defined by the same line segments 402, 404, 406, and 408. While the pattern array 104 is shown in screenshot 700, the character array 310, or any other character array, is not displayed on the touchscreen 102 as the user inputs the unlocking pattern for the first time to set the unlocking pattern for the smartphone 100.

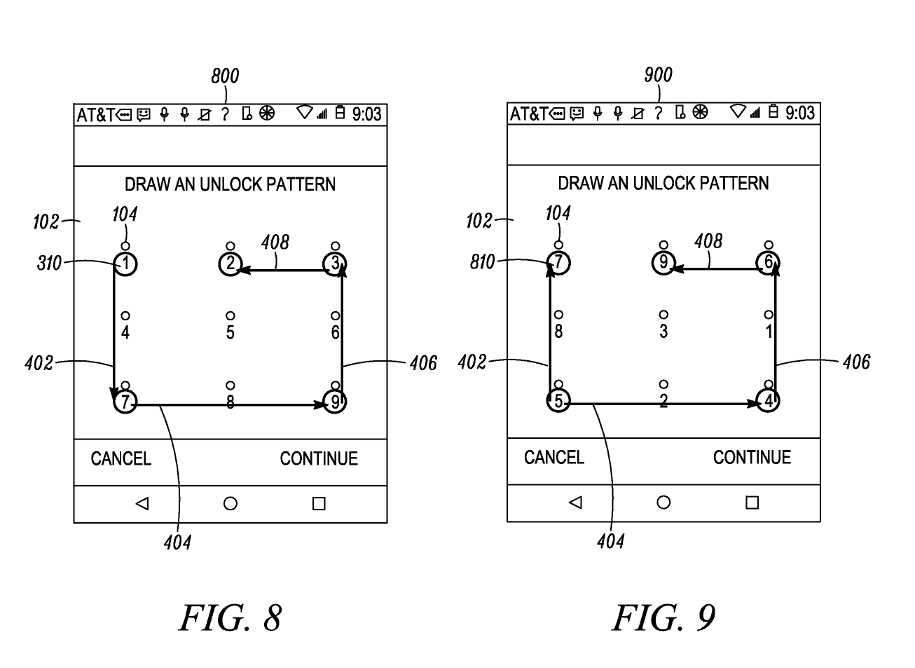

Later, the smartphone 100 receives 606 a command from the user, but detects 608 that the smartphone 100 is in a locked state. Responsively, the smartphone 100 begins a process whereby the user can unlock the smartphone 100. The smartphone 100 generates 610 a character array to overlay onto the pattern array 104 that was displayed while the unlocking pattern was set. For the generated character array, the smartphone 100 maps 612 one or more character sequences to the set unlocking pattern, where the character sequences are located along a path of the unlocking pattern. The smartphone 100 also communicates 614 a prompt to the user to unlock the smartphone 100 using the unlocking pattern or speech. The prompt includes the generated character array overlaid onto the pattern array 104, as indicated in FIG. 8.

FIG. 8 shows a screenshot 800 in which the character array 310 is overlaid onto the pattern array 104. This provides the user with the means to identify each node with a character name. The last node of the unlocking pattern, for example, is node “2” while the character array 310 is being used. The user, knowing the unlocking pattern, can read a character sequence, along the path of the unlocking pattern, from the character array 310 appearing on touchscreen 102. The user, for instance, speaks “1-7-9-3-2,” which is the minimum character sequence for the unlocking pattern using the character array 310.

As the user speaks, the smartphone 100 receives 616 the speech into its microphone 106 and processes the speech to determine the character sequence the user is speaking. The smartphone 100 then compares the spoken character sequence against the one or more character sequences that the smartphone 100 has mapped to the unlocking pattern using the character array 310. If the smartphone 100 maps the full character sequence {1, 4, 7, 8, 9, 6, 3, 2} to the unlocking pattern, for example, then the smartphone 100 would recognize the spoken character sequence {1, 7, 9, 3, 2} as a valid partial character sequence.

In a second example, the smartphone 100 determines that a spoken character sequence {1, 7, 9, 3} is invalid. The character sequence {1, 7, 9, 3} omits the line segment 408, which is part of the unlocking pattern.

In a third example, the smartphone 100 determines that a spoken character sequence {1, 7, 9, 3, 2, 5} is invalid. The character sequence {1, 7, 9, 3, 2, 5} includes a line segment which is not part of the unlocking pattern.

In a fourth example, the smartphone 100 determines that a spoken character sequence {1, 7, 9, 3, 5} is invalid. The character sequence {1, 7, 9, 3, 5} both includes a line segment which is not part of the unlocking pattern and omits the line segment 408, which is part of the unlocking pattern.

In a fifth example, the smartphone 100 determines that a spoken character sequence {2, 3, 9, 7, 1} is invalid. The character sequence {2, 3, 9, 7, 1} does not lie in the unidirectional path of the unlocking pattern. Instead, the character sequence {2, 3, 9, 7, 1} traverses the unlocking pattern in an opposite direction to how the unlocking pattern was set for the smartphone 100.

For a particular embodiment, instead of the smartphone 100 mapping 612 one or more character sequences to the unlocking pattern using the character array 310, the smartphone 100 checks the validity of the spoken character sequence against the set unlocking pattern after the speech is received 616. For instance, the smartphone 100 detects the spoken character sequence and determines it to be {1, 7, 8, 9, 3, 2}. The smartphone 100 then compares the character sequence {1, 7, 8, 9, 3, 2} to the set unlocking pattern using the character array 310 and determines the character sequence to be a valid partial character sequence.

If the smartphone 100 detects 618 that the spoken character sequence is not at least a valid portion of the mapped character sequence, or is not a valid representation of the unlocking pattern, then the smartphone 100 again communicates 614 the prompt to unlock the smartphone 100. If the smartphone 100 detects 618 that the spoken character sequence is at least a valid portion of the mapped character sequence, or a valid representation of the unlocking pattern, then the smartphone 100 unlocks 620 itself. The smartphone 100 then performs the received 606 user command, in addition to any other user commands the smartphone 100 receives.

After a period of inactivity, or after the user instructs the smartphone 100 to sleep, the smartphone 100 transitions from its unlocked state back to a locked state. At a later time, while the smartphone 100 is locked, the smartphone 100 again receives a user command which the smartphone 100 is configured to perform from an unlocked state. The smartphone 100 again communicates a prompt to unlock the smartphone 100 using the unlocking pattern or speech. The prompt includes the pattern array 104. This time, however, the smartphone 100 does not overlay the character array 310 onto the pattern array 104 but instead uses a different character array.

In using a fixed character array, the same full or partial character sequence or sequences are spoken each time the smartphone 100 is unlocked. The more a user repeats a fixed character sequence, the greater the probability the character sequence will be overheard. By using a variable or different character array each time the smartphone 100 is unlocked, a spoken character sequence expires immediately after use. The same character sequence will not be valid the next time the smartphone 100 is unlocked. An example of a different character array for the pattern array 104 is provided by FIG. 9.

FIG. 9 is a screenshot 900 illustrating the use of a character array 810 for unlocking the smartphone 100 in place of the character array 310, which was previously used to unlock the smartphone 100. Comparing the screenshot 900 to the screenshot 800 shows each node of the pattern array 104 to now be labeled differently. The individual characters are the same, but they are arranged differently to form a new character array. The center node, for example, which was previously node “5,” is now node “3.” If the user's preference is to speak the minimum character sequence, he would now speak “7-5-4-6-9,” instead of “1-7-9-3-2,” to unlock the smartphone 100. The next time the user unlocks the smartphone 100, the smartphone 100 would again generate a different character array. Because a current character array is overlaid onto the pattern array 104 each time the smartphone 100 presents the unlocking prompt, the user can read a character sequence from the touchscreen 102 along the path of the unlocking pattern.

For an embodiment, overlaying a character array onto a pattern array is performed multiple times after tactile input is initially received to set an unlocking pattern. The overlaying is performed each of the multiple times using a different character array, such that each of the multiple times a different character sequence is mapped to the unlocking pattern.

In a further embodiment, each of the multiple times a different character array is overlaid onto the pattern array, the smartphone 100 visually displays the different character array overlaying the pattern array, wherein the smartphone 100 is unlocked upon receiving speech that includes at least a portion of the corresponding different character sequence mapped to the unlocking pattern.

For another embodiment, the smartphone 100 communicates a prompt to unlock the electronic device using the unlocking pattern, wherein the overlaying of the character array onto the pattern array is performed each time the prompt is communicated, such that the corresponding different character sequence is mapped to the unlocking pattern each time the prompt is communicated.

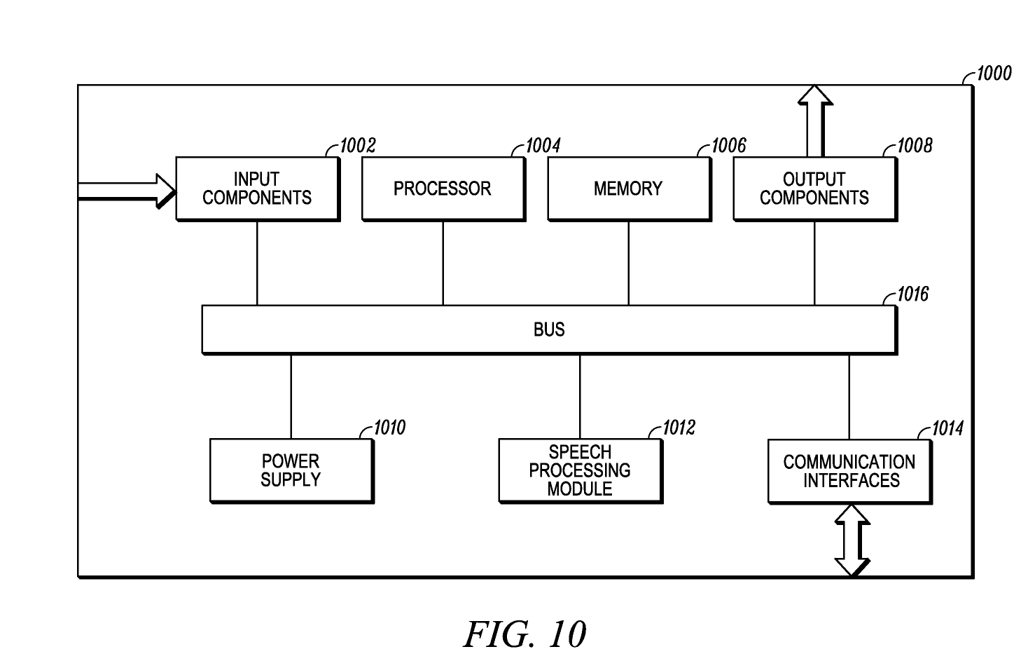

FIG. 10 shows a block diagram of an electronic device 1000, which for a particular embodiment represents the smartphone 100. In other embodiments, the device 1000 represents a smart watch, a phablet, a tablet, a personal media player, a personal or enterprise digital assistant, a laptop, a personal computer, or any other electronic device in accordance with the teachings herein. Included in the block diagram are one or more input components 1002, a processor 1004, memory 1006, one or more output components 1008, a power supply 1010, an SPM 1012, and one or more communication interfaces 1014, which are all operatively interconnected by a bus 1016. A limited number of device components 1002, 1004, 1006, 1008, 1010, 1012, 1014, 1016 are shown in the electronic device 1000 for ease of illustration, and other embodiments may include a lesser or greater number of components in an electronic device 1000. Moreover, other components needed for a commercial embodiment of an electronic device 1000 that incorporates the components shown are omitted from FIG. 10 for clarity with respect to the embodiments described.

In general, the processor 1004 is configured with functionality in accordance with embodiments of the present disclosure as described herein with respect to the previous figures. The processor 1004, for instance, includes arithmetic logic and control circuitry necessary to perform the digital processing, in whole or in part, for the electronic device 1000 to unlock itself in response to voice input in accordance with described embodiments. For one embodiment, the processor 1004 represents a primary microprocessor, also referred to as a central processing unit (“CPU”), of the electronic device 1000. For example, the processor 1004 can represent an application processor of a tablet. In another embodiment, the processor 1004 is an ancillary processor, separate from the CPU. For one embodiment, the ancillary processor is a graphical processing unit for the touchscreen 102 or another graphical output component.

In view of the many possible embodiments to which the principles of the present discussion may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

We claim:

1. A method for using speech to unlock an electronic device having a pattern-based unlocking mechanism, the method comprising:
receiving a tactile input to set an unlocking pattern relative to a pattern array of an electronic device, wherein the unlocking pattern can be used to unlock the electronic device;
mapping a first character sequence to the unlocking pattern;
detecting that the electronic device is in a locked state; and
unlocking the electronic device upon detecting speech that includes at least a portion of the first character sequence mapped to the unlocking pattern.

2. The method of claim 1 wherein mapping the first character sequence to the unlocking pattern comprises:
overlaying a character array onto the pattern array; and
assigning, as the first character sequence, a character sequence of the character array, which is located along a path of the unlocking pattern.

3. The method of claim 2 wherein the character array comprises a fixed character array.

4. The method of claim 3 wherein the overlaying of the character array onto the pattern array is performed only when the tactile input is initially received to set the unlocking pattern.

5. The method of claim 2 wherein the electronic device is unlocked upon detecting speech that includes the entire assigned character sequence located along the path of the unlocking pattern.

6. The method of claim 2 wherein the electronic device is unlocked upon detecting speech that includes only a subset of characters included in the assigned character sequence located along the path of the unlocking pattern.

7. The method of claim 6 wherein the subset of characters includes a minimum number of characters to satisfy an unlocking pin requirement for an operating system of the electronic device.

8. The method of claim 2 wherein the character array comprises a variable character array.

9. The method of claim 8 wherein the overlaying is performed multiple times after the tactile input is initially received to set the unlocking pattern, and the overlaying is performed each of the multiple times using a different character array, such that each of the multiple times a different character sequence is mapped to the unlocking pattern.

10. The method of claim 9 further comprising, each of the multiple times, visually displaying the different character array overlaying the pattern array, wherein the electronic device is unlocked upon receiving speech that includes at least a portion of the corresponding different character sequence mapped to the unlocking pattern.

11. The method of claim 9 further comprising communicating a prompt to unlock the electronic device using the unlocking pattern, wherein the overlaying is performed each time the prompt is communicated, such that the corresponding different character sequence is mapped to the unlocking pattern each time the prompt is communicated.

12. The method of claim 2 wherein the first character sequence is assigned along a unidirectional path of the unlocking pattern.

13. The method of claim 12 wherein the unidirectional path of the unlocking pattern correlates to a plurality of line segments, and wherein the first character sequence mapped to the unlocking pattern comprises at a minimum, for each line segment, a first and a second character correlating to a beginning and an end of the line segment.

14. The method of claim 1 further comprising communicating the at least a portion of the first character sequence using an output component of the electronic device.

15. The method of claim 14 wherein the communicating comprises multiple communications of the at least a portion of the first character sequence using one or more types of output components to implement a user-training process for unlocking the electronic device using speech instead of inputting the unlocking pattern through tactile contact.

16. An electronic device configured for using speech to unlock the electronic device when a pattern-based unlocking mechanism is selected, the electronic device comprising:
an input component configured to receive a tactile input to set an unlocking pattern relative to a pattern array, wherein the unlocking pattern can be used to unlock the electronic device;
a voice-processing module configured to detect characters within speech; and
a processor coupled to the input component and to the voice-processing module, wherein the processor is configured to:
overlay a character array onto the pattern array;
map, to the unlocking pattern, a character sequence of the character array, wherein the sequence is located along a unidirectional path of the unlocking pattern;
detect that the electronic device is in a locked state; and
unlock the electronic device when speech is detected that includes at least a portion of the character sequence mapped to the unlocking pattern.

17. The electronic device of claim 16 further comprising an output component coupled to the processor, wherein the output component is configured to visually display at least one of:
the overlaying of the character array onto the pattern array; or
the at least a portion of the character sequence mapped to the unlocking pattern.

18. The electronic device of claim 16 wherein the processor is configured to unlock the electronic device when speech is detected that includes only a subset of the character sequence mapped to the unlocking pattern when the number of characters in the subset satisfies a minimum number of characters for a user pin.

19. The electronic device of claim 16 wherein the processor is configured to overlay a fixed character array onto the pattern array when the tactile input is initially received to set the unlocking pattern such that only one character sequence is mapped to the unlocking pattern.

20. The electronic device of claim 16 wherein the processor is configured to overlay a different character array onto the pattern array multiple times such that, during each of the multiple times, a correspondingly different character sequence is mapped to the unlocking pattern.
